(19) United States
(12) Patent Application Publication
(10) Pub. No.: US 2011/0087783 A1
(43) Pub. Date: Apr. 14, 2011

(54) ALLOCATING RESOURCES OF A NODE IN A SERVER FARM

(76) Inventors: Siddhartha Annapureddy, Palo Alto, CA (US); Pierpaolo Baccichet, Palo Alto, CA (US)

(21) Appl. No.: 12/576,848

(22) Filed: Oct. 9, 2009

(51) Int. Cl. G06F 15/16

(52) U.S. Cl. 709/226

(57) ABSTRACT

Allocating resources of a node in a cluster of nodes without requiring a central server. Resource metrics of the node are monitored at a service manager of the node. Resource usage of the node is disseminated to a plurality of neighboring nodes at the service manager of the node. Resource usage of the neighboring nodes is gathered at the service manager of the node. A request from an external client is received such that the request can be redirected to an appropriate node based on user directed constraints, the resource metrics of the node and the resource usage of the neighboring nodes.

### BACKGROUND

Server farms are used to for a variety of computing needs. Computer systems in a server farm may be managed manually to comply with resource constraints. Such manual management may be tedious. Additionally, cloud computing makes it possible for users to rent the use of computer systems. In doing so, it is important to manage the resources of the computer systems in the cloud so that a minimum number of computer systems satisfy the workload. One solution is to use a central server to manage the resources of all other computer systems in a server farm. Such an approach has drawbacks such as a scalability and reliability bottleneck.

### BRIEF DESCRIPTION OF THE DRAWINGS

FIG. 1 illustrates a block diagram of an example cluster of nodes in accordance with embodiments of the present technology.

FIG. 2 illustrates a block diagram of an example node for use in a cluster of nodes comprising multiple components in accordance with embodiments of the present technology.

FIG. 3 illustrates a flowchart of an example method for allocating resources of a node in a cluster of nodes in accordance with embodiments of the present technology.

FIG. 4 illustrates a diagram of an example computer system upon which embodiments of the present technology may be implemented.

The drawings referred to in this description of embodiments should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present description of embodiments, discussions utilizing terms such as “monitoring,” “disseminating,” “gathering,” “directing,” “redirecting,” “receiving,” “allocating,” “communicating,” “responding,” “discovering,” “joining,” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer systems such as, for example, optical and mechanical computers.

### Overview of Discussion

Embodiments of the present technology are for allocating resources of a node in a cluster of nodes. For example, a node may be one of several nodes and may be a server computer system which is part of a server farm or a node in cloud used for cloud computing. Each node has a limited amount of resources that may be used to perform services for an external client. Each node comprises a service manager. The service managers manage the resources of the nodes in the cluster of nodes. Peer to peer technology may be used to manage the cluster of nodes.

In one embodiment, a service manager of a node is aware of resource metrics of the node as well as services being performed by the node. This information is communicated to other nodes in the cluster of nodes so that every node is aware of the status of a partial set of nodes. The service manager may also comprise a user directed allocator which is capable of receiving criteria from the user as to how the resources of the node should be used. When an external client sends a request for a service, the service manager and the user directed allocator determine the node or nodes best suited to satisfy the request for a service. The service manager may determine that it will satisfy the service in the node the service manager is running on. If the service manager determines that another node is best suited to satisfy the request, then the request for service is redirected to the other node best suited to satisfy the request. Once the second service manager receives the request for a service from the first service manager, the second service manager sends a response to the first service manager which then redirects the response to the external client that sent the request for a service.

Embodiments of the present technology are well suited to allocate the resources of nodes in a cluster of nodes without requiring a central computer server to direct all requests for services and to manage the resources of all nodes. By not requiring a central server, the present technology is scalable without creating a bottle neck effect because all requests and managing do not go through one central server. Instead, every service manager of every node is capable of managing resources and directing requests for services. Because every service manager is capable of such tasks, the present technology is also more reliable than a system that uses only one central server.

The following discussion will demonstrate various hardware, software, and firmware components that are used with and in computer systems for allocating resources of a node in a cluster of nodes using various embodiments of the present technology. Furthermore, the systems and methods may include some, all, or none of the hardware, software, and firmware components discussed below.

The following discussion will center on computer systems or nodes operating in a cluster of nodes. A cluster of nodes may be a peer-to-peer computer environment. It should be appreciated that a peer-to-peer computer environment is well known in the art and is also known as a peer-to-peer network and is often abbreviated as P2P. It should be understood that a peer-to-peer computer environment may comprise multiple computer systems, and may include routers and switches, of varying types that communicate with each other using designated protocols. In one embodiment, a peer-to-peer computer environment is a distributed network architecture that is composed of participants that make a portion of their resources (such as processing power, disk storage, and network bandwidth) available directly to their peers without intermediary network hosts or servers. In one embodiment, peer-to-peer technology is used to manage the cluster of nodes.

### Embodiments of a System for Allocating Resources of a Node in a Peer-to-Peer Computer Environment

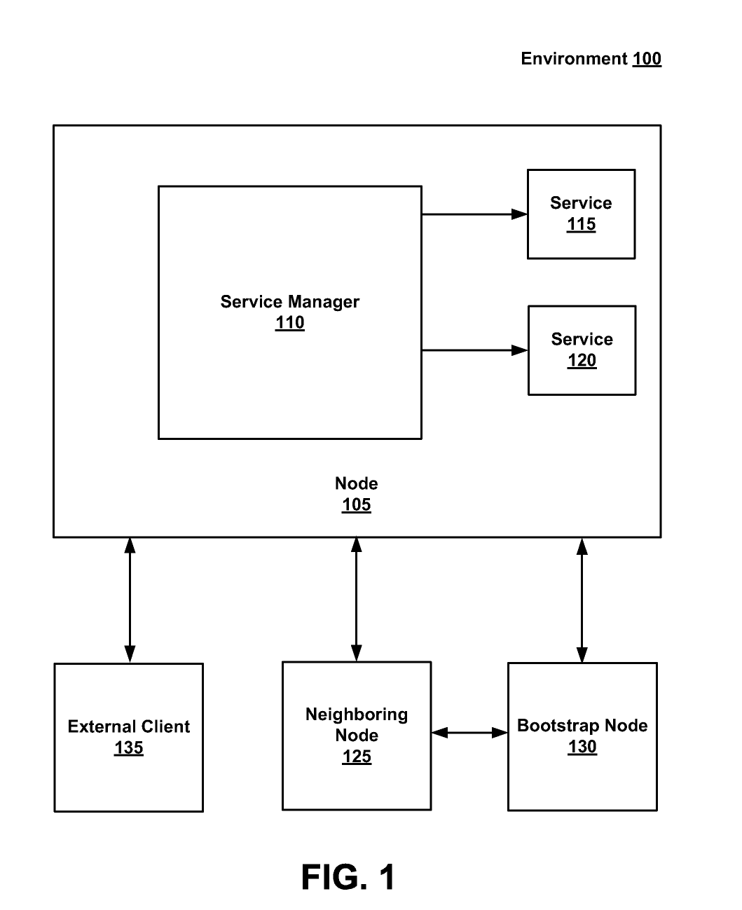

With reference now to FIG. 1, a block diagram of an example cluster of nodes for use in allocating resources of a node in a cluster of nodes. Environment 100 includes node 105, service manager 110, service 115 and 120, neighboring node 125, bootstrap node 130 and external client 135. Environment 100 comprises components that may or may not be used with different embodiments of the present technology and should not be construed to limit the present technology.

In one embodiment, environment 100 includes node 105. Node 105 may be a computer system including a server computer system or a personal computer system. Node 105 may be any type of machine capable of computing data and communicating with other similar machines over a network. Node 105 may be part of a server farm or a computer system used in cloud computing. In one embodiment, node 105 is capable of carrying out services such as services 115 and 120. In one embodiment, node 105 is a virtual computer. Node 105 may have a limited number of resources for carrying out services. Such resources may include central processing unit (CPU) usage, memory usage, quality of service (QOS), bandwidth, storage capacity, etc.

In one embodiment, node 105 carries out services 115 and 120. Services 115 and 120 may be any type of service that a computer system may be expected to execute by a user. Services 115 and 120 may be running an application, computing data, storing data, transferring data, etc. In one embodiment, node 105 is requested to execute services 115 and 120 by external client 135.

External client 135, in one embodiment, is a computer system. For example, external client 135 may be a personal computer connected over a peer-to-peer computer network to node 105. In one embodiment, external client 135 requires a service to be run on a computer system external to external client 135. In one embodiment, external client 135 is capable of sending requests for services over a cluster of nodes and receiving a response back from the cluster of nodes.

In one embodiment, node 105 comprises service manager 110. Service manager 110 is capable of operating on or with node 105 to carry out various tasks. In one embodiment, service manager 110 employs a light-weight peer-to-peer gossip protocol to communicate with other nodes. In one embodiment, the gossip protocol is an unstructured approach but still follows a certain algorithm. Such an approach can allow each node to know is place in the cluster of nodes while allowing other nodes to be added to the cluster of nodes in an ad hoc fashion. In one embodiment, a peer-to-peer gossip layer may be constructed to choose neighboring nodes based on locality awareness.

In one embodiment, node 105 communicates with all other nodes in the cluster of nodes. In one embodiment, node 105 only communicates with a subset of nodes in the cluster of nodes. Nodes in the subset of nodes are known as neighboring nodes. In one embodiment, node 105 is in communication with neighboring node 125 which is a neighboring node to node 105 in this example cluster of nodes. It should be appreciated that neighboring nodes may or may not be physically proximate to each other. In one embodiment, neighboring nodes are selected based on the locality of the nodes. In one embodiment, node 105 communicates with any number of neighboring nodes. In one embodiment, node 105 communicates with 10 or less neighboring nodes.

In one embodiment, node 105 may not initially be part of the cluster of nodes of environment 100. To join the cluster of nodes, node 105, in one embodiment, will first contact bootstrap node 130. In one embodiment, a bootstrap node is a specific subset of nodes in the cluster of nodes. In one embodiment, a node in a cluster of nodes will communicate with only one bootstrap node. In one embodiment, each bootstrap node communicates with all other bootstrap nodes and a subset of nodes that is unique to each bootstrap node in the cluster of nodes. In one embodiment, the unique subset of nodes forms neighboring nodes for nodes within the unique subset. For example, node 105 will communicate with a plurality of neighboring nodes, including neighboring node 125, and one bootstrap node such as bootstrap node 130. In one embodiment, a bootstrap node may act as a central node for a given subset of nodes.

In one embodiment, a node may discover neighboring nodes through the bootstrap node that was communicated with to join the cluster of nodes. In one embodiment, a node may discover neighboring nodes through an existing neighboring node. For example, node 105 may join the cluster of nodes of environment 100 by first communicating with bootstrap node 130. Node 105 may then discover neighboring node 125 through bootstrap node 130, at this point neighboring node 125 becomes an existing neighboring node. After which, node 105 may discover additional neighboring nodes through either neighboring node 125 or bootstrap node 130. Thus, if all nodes in the cluster of nodes are in contact with a bootstrap node and all bootstrap nodes are in contact with each other, records that are maintained by the bootstrap nodes will span the entire cluster of nodes.

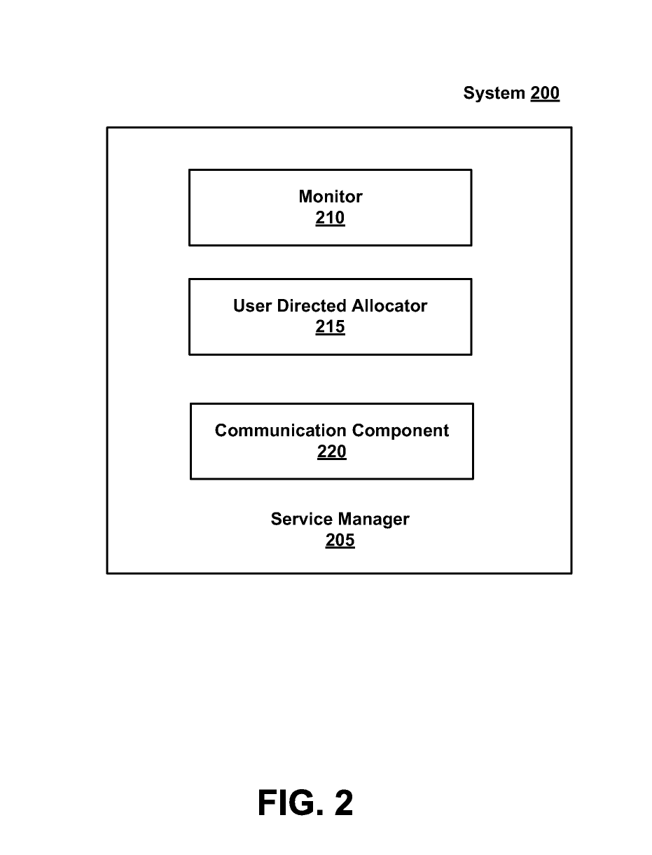

With reference now to FIG. 2, a block diagram of system 200 including service manager 205 configured to run on or with a node in the cluster of nodes of FIG. 1. System 100 includes service manager 205, monitor 210, user directed allocator 215 and communications component 220. System 200 comprises components that may or may not be used with different embodiments of the present technology and should not be construed to limit the present technology.

In one embodiment, service manager 205 has all of the features of service manager 110 of FIG. 1. In one embodiment, service manager 205 is part of or coupled with a node in a cluster of nodes and includes monitor 210, user directed allocator 215 and communications component 220. It should be appreciated that service manager 205 may be hardware, software, firmware or any combination thereof. In one embodiment, service manager 205 employs an algorithm or algorithms to carry out its functions.

In one embodiment, monitor 210 is capable of collecting resource metrics of services already running on the node. For example, the node may be running both services 115 and 120 of FIG. 1 and monitor 210 is capable of collecting information regarding CPU usage, memory usage, bandwidth usage, the number of external clients being served and other resource usage that is being consumed by services 115 and 120. The resource metrics may also be referred to as a resource record. In one embodiment, monitor 210 is capable of independently gathering resource metrics. In one embodiment, each active service on the node is capable of communicating its resource usage to monitor 210 using a network protocol.

In one embodiment, communications component 220 is capable of disseminating or propagating the resource metrics collected by monitor 210 to the nodes neighboring nodes. In one embodiment, communications component 220 is also capable of receiving or gathering information regarding the resource metrics of neighboring nodes. Thus each node in the cluster of nodes maintains an array of resource records both of the node itself and its neighboring nodes. In one embodiment, communications component 220 employs a peer-to-peer gossip protocol to communicate with neighboring nodes. In one embodiment, communications component 220 will periodically exchange resource records with the neighboring nodes.

In one embodiment, user directed allocator 215 is capable of receiving user specified criteria as to how the resources of the node should be used. For example, a user may specify that the CPU usage of the node should not exceed a given threshold. In various embodiments, the user may specify any number of criteria regarding a variety of resources including, usage thresholds, a maximum or minimum number of services to be run on the node, etc. In one embodiment, user directed allocator 215 employs algorithms to satisfy the user specified criteria. In one embodiment, user directed allocator 215 will run an algorithm each time a request for a service is received to determine the best node suited to satisfy the requested service.

In one embodiment, user directed allocator 215 is capable of receiving or fielding requests for services from an external client such as external client 135 of FIG. 1. User directed allocator 215, in one embodiment, makes a determination as to which node will best satisfy the request for services based on the user directed criteria and the resource metrics of the nodes in the cluster of nodes. User directed allocator will then redirect the request for services to the node best suited to satisfy the request for services. In one embodiment, user directed allocator 215 is capable of responding back to the external client with information regarding the satisfaction of the requested services. In this manner, the external client is able to send the request for services to any node in the cluster of nodes and have the request for services redirected to the noted best suited to satisfy the request for services. In one embodiment, once the request for services is redirected to the service manager of another node, that service manager will respond back to the service manager that redirected the request for services, that response will be redirected to the external client that sent the request for services.

In one embodiment, user directed allocator 215 is only able to make a determination of the node best suited to satisfy the request for services from among the neighboring nodes. However, in one embodiment, the bootstrap node in communication with the node is able to redirect the request to a node that is not a neighboring node of the node that received the request for services from the external client.

### Operation

More generally, in embodiments in accordance with the present invention are utilized to allocate the resources of a node in a cluster of nodes while increasing reliability and scalability.

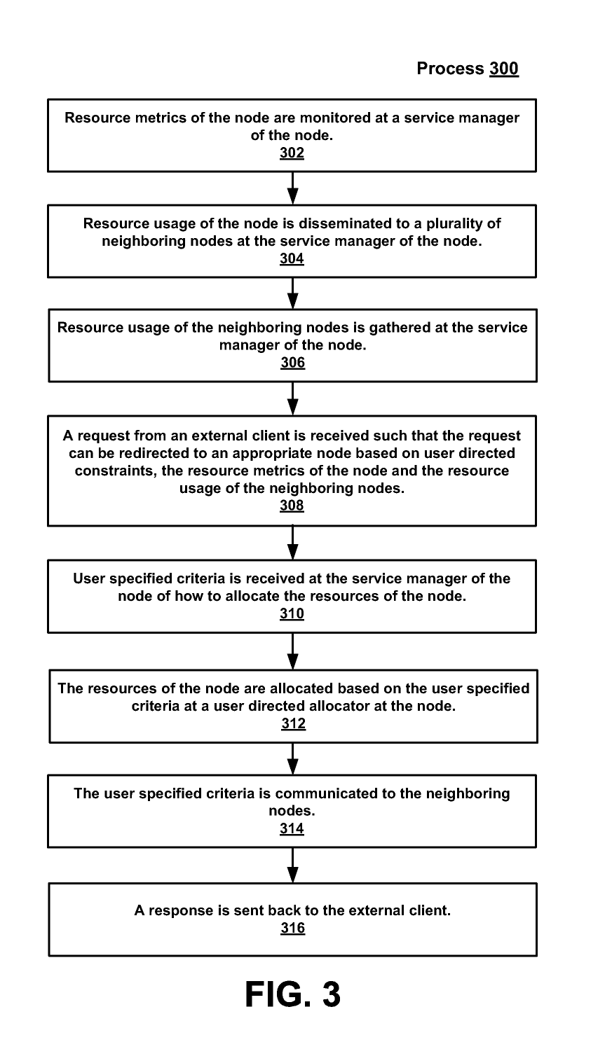

FIG. 3 is a flowchart illustrating process 300 for allocating resources of a node in a cluster of nodes, in accordance with one embodiment of the present invention. In one embodiment, process 300 is a computer implemented method that is carried out by processors and electrical components under the control of computer usable and computer executable instructions. The computer usable and computer executable instructions reside, for example, in data storage features such as computer usable volatile and non-volatile memory. However, the computer usable and computer executable instructions may reside in any type of computer usable storage medium. In one embodiment, process 300 is performed by service manager 110 of FIG. 1. In one embodiment, the methods may reside in a computer usable storage medium having instructions embodied therein that when executed cause a computer system to perform the method.

At 302, resource metrics of the node are monitored at a service manager of the node. For example, this may be accomplished using monitor 210 of FIG. 2.

At 304, resource usage of the node is disseminated to a plurality of neighboring nodes at the service manager of the node. In one embodiment, the resource usage is disseminated using a peer-to-peer gossip protocol. In one embodiment, the resource usage of the node is disseminated using communications component 220.

At 306, resource usage of the neighboring nodes is gathered at the service manager of the node. In one embodiment, the resource usage of the neighboring nodes is gathered using a peer-to-peer gossip protocol. In one embodiment, the resource usage of the neighboring nodes is gathered using communications component 220.

At 308, a request from an external client is received such that the request can be redirected to an appropriate node based on user directed constraints, the resource metrics of the node and the resource usage of the neighboring nodes. In one embodiment, service manager 205 of FIG. 2 employs user directed allocator 215 to make a determination as to which node will best satisfy the request for services and then redirect the request.

At 310, user specified criteria are received at the service manager of the node of how to allocate the resources of the node. In one embodiment, the service manager is service manager 205 of FIG. 2.

At 312, the resources of the node are allocated based on the user specified criteria at a user directed allocator at the node. In one embodiment, this step is accomplished using user directed allocator 215 of FIG. 2.

At 314, the user specified criteria is communicated to the neighboring nodes. In one embodiment, this may be accomplished using either user directed allocator 215 or communications component 220 of FIG. 2.

In one embodiment, the user specified criteria may be a constraint requiring the service requested by the external client to be satisfied by a node based on the location of the node. In one embodiment, this location based satisfaction requires a locality awareness meaning node must be aware of its physical location and the physical location of neighboring nodes and the external clients. In one embodiment, the user directed allocator will satisfy the request for services, or redirect the request for services, based on locality awareness of the nodes and the external client. For example, a node may be located in North America but have neighboring nodes located in Asia and Europe. An external client located in North America may have its requests for services satisfied by a node located in North America and an external client located in Asia may have its requests for services satisfied by a node located in Asia.

In one embodiment, process 300 comprises a request for services received from an external client. In one embodiment, process 300 comprises the node joining the peer-to-peer computer environment by contacting a bootstrap node. In one embodiment, process 300 comprises discovering neighboring nodes through a bootstrap node. In one embodiment, process 300 comprises discovering neighboring nodes through existing neighboring nodes.

At 316, a response is sent back to the external client. In one embodiment, such a response may include how the service requested by the external client is being satisfied, which node or nodes is satisfying the request and where the request was redirected. In one embodiment, a first service manager determines that a second service manager is best suited for satisfying the request for service, the request will be redirected to the second service manager which will then respond back to the first service manager, this response will be redirected to the external client that sent the request for service.

### Example Computer System Environment

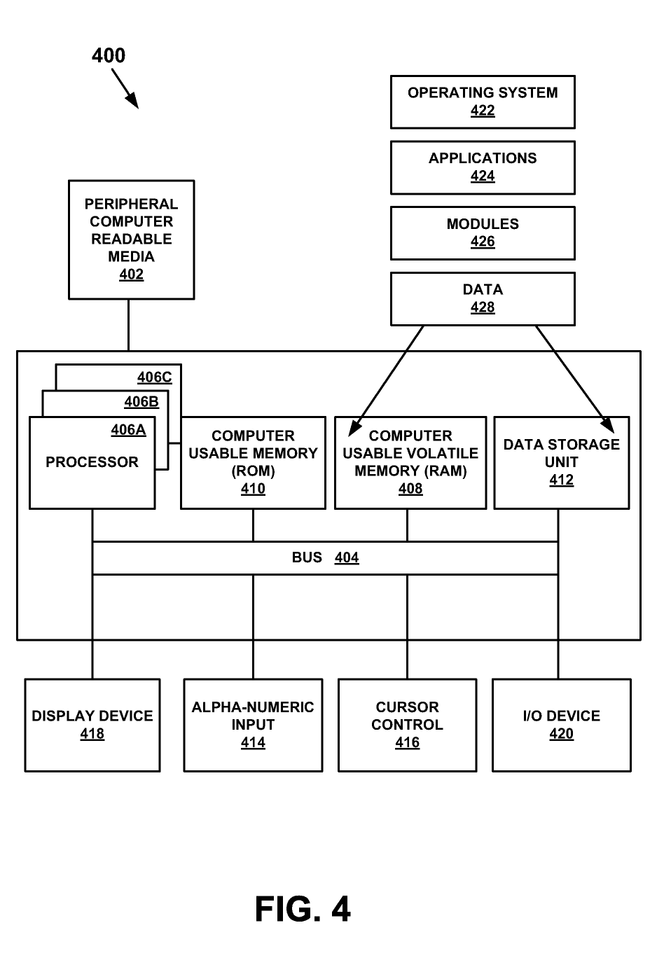

With reference now to FIG. 4, portions of embodiments of the technology for providing a communication composed of computer-readable and computer-executable instructions that reside, for example, in computer-usable media of a computer system. That is, FIG. 4 illustrates one example of a type of computer that can be used to implement embodiments of the present technology.

FIG. 4 illustrates an example computer system 400 used in accordance with embodiments of the present technology. It is appreciated that system 400 of FIG. 4 is an example only and that embodiments of the present technology can operate on or within a number of different computer systems including general purpose networked computer systems, peer-to-peer networked computer systems, embedded computer systems, routers, switches, server devices, user devices, various intermediate devices/artifacts, stand alone computer systems, mobile phones, personal data assistants, and the like. As shown in FIG. 4, computer system 400 of FIG. 4 is well adapted to having peripheral computer readable media 402 such as, for example, a floppy disk, a compact disc, and the like coupled thereto.

System 400 of FIG. 4 includes an address/data bus 404 for communicating information, and a processor 406A coupled to bus 404 for processing information and instructions. As depicted in FIG. 4, system 400 is also well suited to a multi-processor environment in which a plurality of processors 406A, 406B, and 406C are present. Conversely, system 400 is also well suited to having a single processor such as, for example, processor 406A. Processors 406A, 406B, and 406C may be any of various types of microprocessors. System 400 also includes data storage features such as a computer usable volatile memory 408, e.g. random access memory (RAM), coupled to bus 404 for storing information and instructions for processors 406A, 406B, and 406C.

System 400 also includes computer usable non-volatile memory 410, e.g. read only memory (ROM), coupled to bus 404 for storing static information and instructions for processors 406A, 406B, and 406C. Also present in system 400 is a data storage unit 412 (e.g., a magnetic or optical disk and disk drive) coupled to bus 404 for storing information and instructions. System 400 also includes an optional alpha-numeric input device 414 including alphanumeric and function keys coupled to bus 404 for communicating information and command selections to processor 406A or processors 406A, 406B, and 406C. System 400 also includes an optional cursor control device 416 coupled to bus 404 for communicating user input information and command selections to processor 406A or processors 406A, 406B, and 406C. System 400 of the present embodiment also includes an optional display device 418 coupled to bus 404 for displaying information.

Referring still to FIG. 4, optional display device 418 of FIG. 4 may be a liquid crystal device, cathode ray tube, plasma display device or other display device suitable for creating graphic images and alpha-numeric characters recognizable to a user. Optional cursor control device 416 allows the computer user to dynamically signal the movement of a visible symbol (cursor) on a display screen of display device 418. Many implementations of cursor control device 416 are known in the art including a trackball, mouse, touch pad, joystick or special keys on alpha-numeric input device 414 capable of signaling movement of a given direction or manner of displacement. Alternatively, it will be appreciated that a cursor can be directed and/or activated via input from alpha-numeric input device 414 using special keys and key sequence commands.

System 400 is also well suited to having a cursor directed by other means such as, for example, voice commands. System 400 also includes an I/O device 420 for coupling system 400 with external entities. For example, in one embodiment, I/O device 420 is a modem for enabling wired or wireless communications between system 400 and an external network such as, but not limited to, the Internet. System 400 is also well suited for operation in a cluster of nodes or a peer-to-peer computer environment.

Referring still to FIG. 4, various other components are depicted for system 400. Specifically, when present, an operating system 422, applications 424, modules 426, and data 428 are shown as typically residing in one or some combination of computer usable volatile memory 408, e.g. random access memory (RAM), and data storage unit 412. However, it is appreciated that in some embodiments, operating system 422 may be stored in other locations such as on a network or on a flash drive; and that further, operating system 422 may be accessed from a remote location via, for example, a coupling to the internet. In one embodiment, the present technology, for example, is stored as an application 424 or module 426 in memory locations within RAM 408 and memory areas within data storage unit 412. Embodiments of the present technology may be applied to one or more elements of described system 400. For example, a method of modifying user interface 225A of device 115A may be applied to operating system 422, applications 424, modules 426, and/or data 428.

The computing system 400 is only one example of a suitable computing environment and is not intended to suggest any limitation as to the scope of use or functionality of the present technology. Neither should the computing environment 400 be interpreted as having any dependency or requirement relating to any one or combination of components illustrated in the example computing system 400.

Embodiments of the present technology may be described in the general context of computer-executable instructions, such as program modules, being executed by a computer. Generally, program modules include routines, programs, objects, components, data structures, etc., that perform particular tasks or implement particular abstract data types. Embodiments of the present technology may also be practiced in distributed computing environments where tasks are performed by remote processing devices that are linked through a communications network. In a distributed computing environment, program modules may be located in both local and remote computer-storage media including memory-storage devices.

Although the subject matter is described in a language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer implemented method for allocating resources of a node in a cluster of nodes without requiring a central server, said method comprising:
monitoring resource metrics of said node at a service manager of said node;
disseminating resource usage of said node to a plurality of neighboring nodes at said service manager of said node;
gathering resource usage of said neighboring nodes at said service manager of said node; and
such that upon receiving a request from an external client, said request can be redirected to an appropriate node based on user directed constraints, said resource metrics of said node and said resource usage of said neighboring nodes.

2. The computer implemented method of claim 1, further comprising:
receiving user specified criteria at said service manager of said node of how to allocate said resources of said node;
allocating said resources of said node based on said user specified criteria at a user directed allocator at said node; and
communicating said user specified criteria to said neighboring nodes.

3. The computer implemented method of claim 1, further comprising:
receiving a request for services from said external client.

4. The computer implemented method of claim 1, further comprising:
responding back to said external client.

5. The computer implemented method of claim 1, further comprising:
joining said node to said cluster of nodes by contacting a bootstrap node.

6. The computer implemented method of claim 5, further comprising:
discovering a neighboring node through said bootstrap node.

7. The computer implemented method of claim 1, further comprising:
discovering a neighboring node through an existing neighboring node.

8. The computer implemented method of claim 1, further comprising:
redirecting said request to a node based on locality awareness of said node and said external client.

9. The computer implemented method of claim 1 wherein said method uses a peer to peer gossip protocol for said disseminating and said gathering.

10. A computer implemented method for allocating resources of a node in a cluster of nodes without requiring a central server, said method comprising:
receiving a request for services from an external client to said cluster of nodes;
monitoring resource metrics of said node at a service manager of said node;
disseminating resource usage of said node to a plurality of neighboring nodes;
gathering resource usage of said neighboring nodes;
receiving a request for services from an external client to said cluster of nodes, such that upon said receiving said request from an external client, said request can be redirected to an appropriate node based on user directed constraints, said resource metrics of said node and said resource usage of said neighboring nodes; and
responding to said external client.

11. The computer implemented method of claim 10, further comprising:
receiving user specified criteria at said service manager of said node of how to allocate said resources of said node;
allocating said resources of said node based on said user specified criteria at a user directed allocator at said node; and
communicating said user specified criteria to said neighboring nodes.

12. The computer implemented method of claim 10, further comprising:
joining said node to said cluster of nodes by contacting a bootstrap node.

13. The computer implemented method of claim 12, further comprising:
discovering a neighboring node through said bootstrap node.

14. The computer implemented method of claim 10, further comprising:
discovering a neighboring node through an existing neighboring node.

15. The computer implemented method of claim 10, further comprising:
redirecting said request to a node based on locality awareness of said node and said external client.

16. The computer implemented method of claim 10 wherein said method uses a peer to peer gossip protocol for said disseminating and said gathering.

17. A computer-usable storage medium having instructions embodied therein that when executed cause a computer system to perform a method for allocating resources of a node in a cluster of nodes without requiring a central server, said method comprising:
monitoring resource metrics of said node at a service manager of said node;
disseminating resource usage of said node to a plurality of neighboring nodes at said service manager of said node;
gathering resource usage of said neighboring nodes at said service manager of said node; and
such that upon receiving a request from an external client, said request can be redirected to an appropriate node based on user directed constraints, said resource metrics of said node and said resource usage of said neighboring nodes.

18. The computer-usable storage medium of claim 17, further comprising:
receiving user specified criteria at said service manager of said node of how to allocate said resources of said node;
allocating said resources of said node based on said user specified criteria at a user directed allocator at said node; and
communicating said user specified criteria to said neighboring nodes.

19. The computer-usable storage medium of claim 17, further comprising:
joining said node to said cluster of nodes by contacting a bootstrap node.

20. The computer-usable storage medium of claim 19, further comprising:
discovering a neighboring node through said bootstrap node.

20. The computer-usable storage medium of claim 17, further comprising:
discovering a neighboring node through an existing neighboring node.

21. The computer-usable storage medium of claim 17, further comprising:
redirecting said request to a node based on locality awareness of said node and said external client.

22. The computer-usable storage medium of claim 17 wherein said method uses a peer to peer gossip protocol for said disseminating and said gathering.

23. A system for allocating resources of a node in a cluster of nodes without a need for a central server, said system comprising:
a monitor configured to collect resource metrics of said node;
a communications component configured to disseminate resource usage of said node to a plurality of neighboring nodes and gather resource usage of said neighboring nodes; and
a user-directed allocator configured to receive requests for services from an external client and redirect said requests for services to an appropriate node.

24. The system of claim 23 further comprising:
an external client configured to send request for services to said node and receive a response from said node.

25. The system of claim 23 further comprising:
a boot strap node.
